(19) United States
(12) Patent Application Publication
(10) Pub. No.: US 2005/0022913 A1
(43) Pub. Date: Feb. 3, 2005

(54) Wheel having cushioning device

(76) Inventor: Tseng Kun Chan, Chong Ho City (TW)

Correspondence Address: Tseng Kun Chan, P.O. Box 10-69, Chong Ho, Taipei, 235, TW

(21) Appl. No.: 10/633,809

(22) Filed: Aug. 1, 2003

(51) Int. Cl. B60B 9/08

(52) U.S. Cl. 152/97; 152/99

(57) ABSTRACT

A wheel includes a wheel rim, a hub disposed within the wheel rim, and a number of cushioning devices coupled between the hub and the wheel rim, to provide a cushioning force between the hub and the wheel rim, and to allow cycle riders to comfortably ride the cycles. Each of the cushioning devices includes a tube extended from the hub, and a duct extended from the wheel rim, and one or more cushioning members disposed between the tube and the duct. The cushioning member may be one or more springs, or one or more resilient pads. The cushioning devices may be hydraulic cylinders or pneumatic cylinders, or the other cushioning members.

### BACKGROUND OF THE INVENTION

1. Field of the Invention

The present invention relates to a wheel, and more particularly to a wheel having a cushioning mechanism or device.

2. Description of the Prior Art

Typical wheels comprise a number of spokes including one end hooked to a wheel rim and the other end solidly secured to a hub with fasteners, to couple the spokes between the hub and the wheel rim. Normally, the spokes include a one-integral piece having no resilient or cushioning structure or mechanism or device for cushioning the spokes, such that the spokes may not provide suitable resilient or cushioning or spongy force against the wheels, and such that the wheels may not provide suitable resilient or cushioning or spongy force to the cycle riders.

The present invention has arisen to mitigate and/or obviate the afore-described disadvantages of the conventional wheels.

### SUMMARY OF THE INVENTION

The primary objective of the present invention is to provide a wheel including a cushioning mechanism or device for cushioning the spokes or the wheel.

In accordance with one aspect of the invention, there is provided a wheel comprising a wheel rim, a hub disposed within the wheel rim, and a plurality of cushioning devices coupled between the hub and the wheel rim, to provide a cushioning force between the hub and the wheel rim, and to allow cycle riders to comfortably ride the cycles.

Each of the cushioning devices includes a tube extended from the hub, and a duct extended from the wheel rim, and one or more cushioning members disposed between the tube and the duct, to provide the cushioning force between the tube and the duct and thus between the hub and the wheel rim.

Each of the tubes and the ducts includes a bore formed therein to receive the cushioning member. The cushioning member may be one or more springs, or one or more resilient pads. Each of the cushioning devices includes a barrel slidably engaged between the tube and the hub, and a sealing ring engaged between the barrel and the tube, and another sealing ring engaged between the barrel and the hub.

The cushioning devices may be hydraulic cylinders or pneumatic cylinders, or the other cushioning members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a wheel in accordance with the present invention;

FIG. 2 is a partial exploded view of the wheel;

FIG. 3 is a partial cross sectional view of the wheel, taken along lines 3-3 of FIG. 1;

FIG. 4 is an enlarged partial cross sectional view of the wheel;

FIG. 5 is a perspective view illustrating the other embodiment of the wheel;

FIG. 6 is a partial exploded view of the wheel as shown in FIG. 5;

FIGS. 7, 8 are partial cross sectional views similar to FIG. 3, illustrating the further embodiments of the wheel; and

FIGS. 9, 10 are enlarged partial cross sectional views of the wheels as shown in FIGS. 7, 8 respectively.

### DETAILED DESCRIPTION OF THE PREFERRED EMBODIMENT

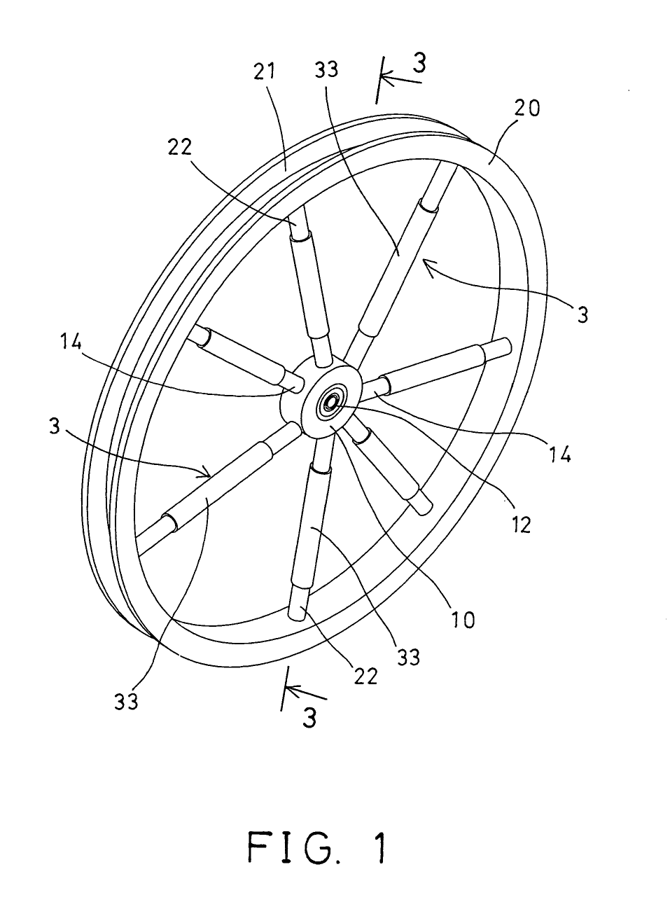

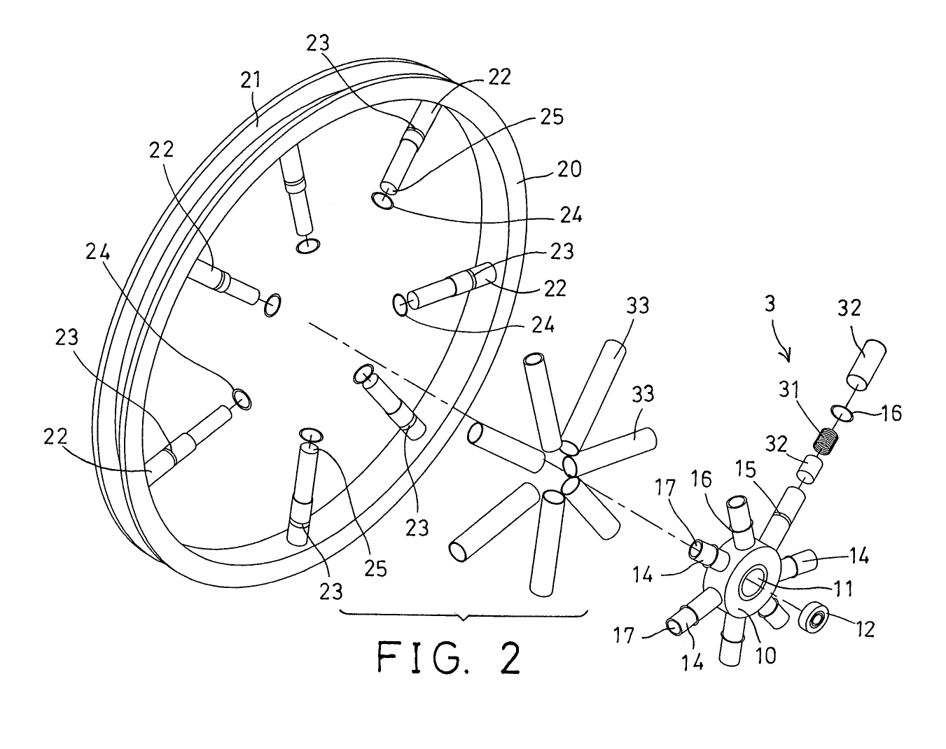

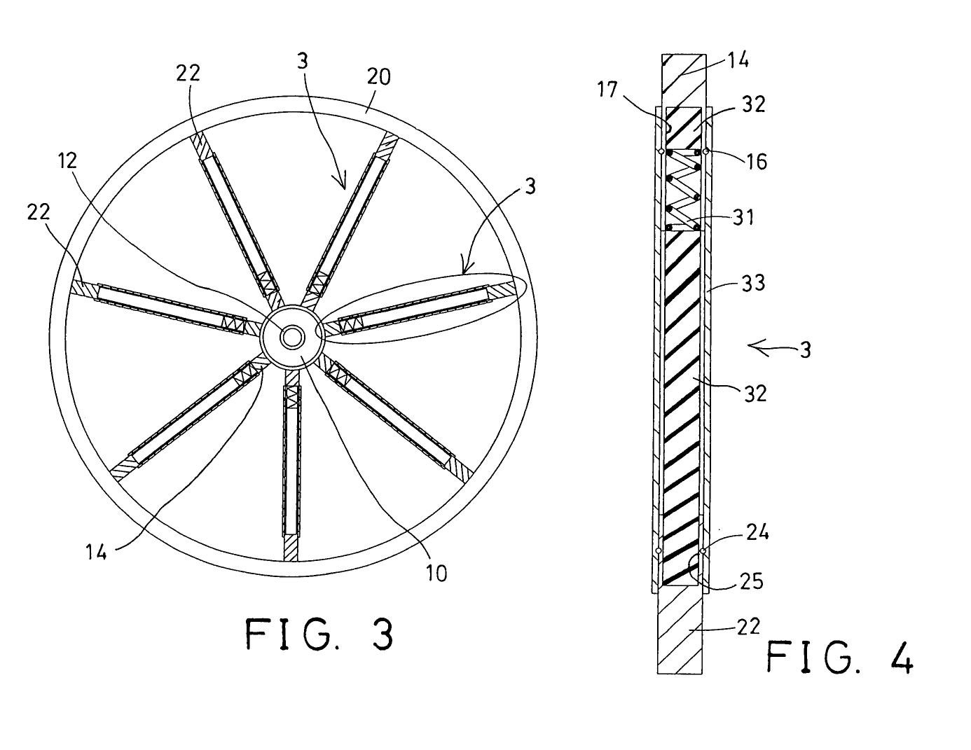

Referring to the drawings, and initially to FIGS. 1-4, a wheel in accordance with the present invention comprises a hub 10 and a wheel rim 20 to be resiliently coupled together with a number of cushioning spokes or devices 3. The hub 10 includes a bore 11 for receiving a bearing 12 and for rotatably attaching to cycles. The wheel rim 20 includes an outer peripheral recess 21 formed therein for receiving outer tire (not shown) or the like.

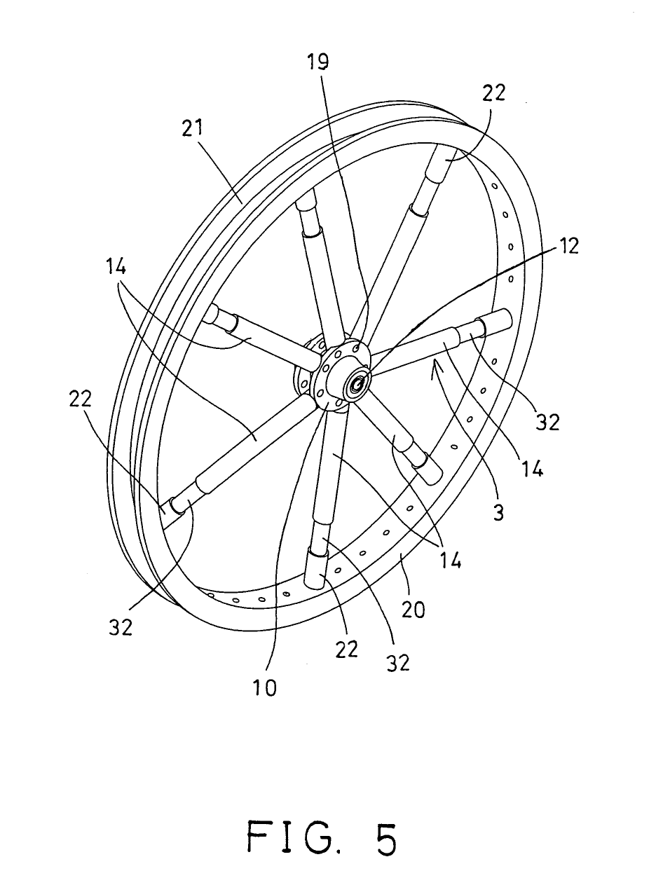

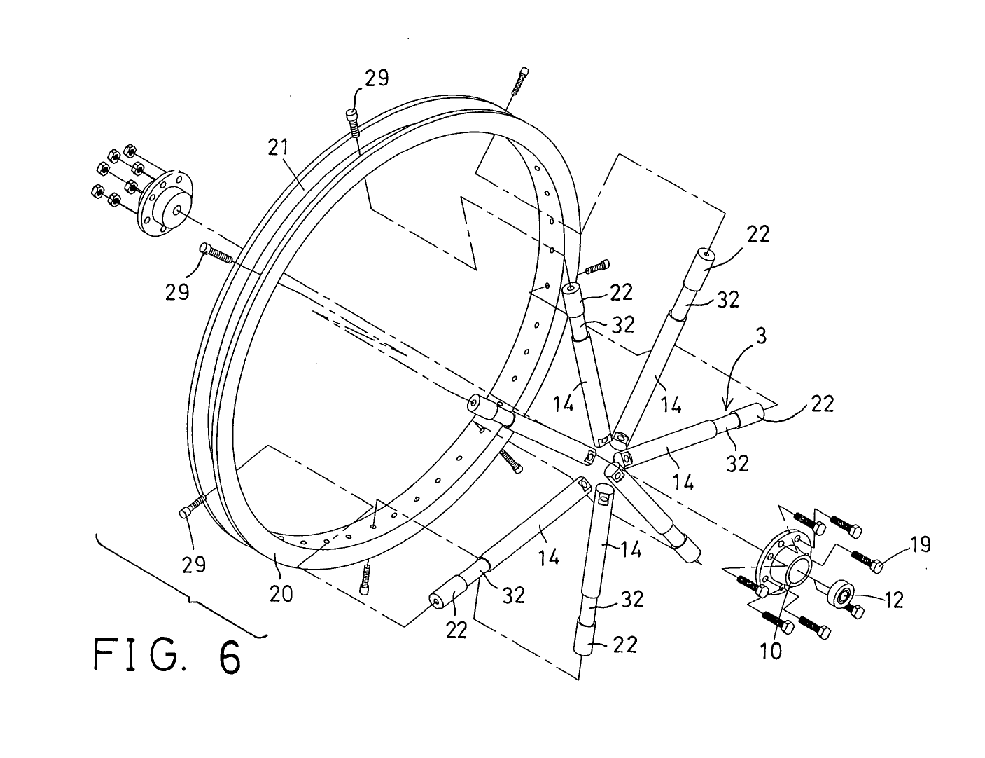

Each of the cushioning devices 3 includes a tube 14 extended from the hub 10 (FIGS. 1-3) or secured to the hub 10 with fasteners 19 or the like (FIGS. 5, 6), and a duct 22 extended from the wheel rim 20 (FIGS. 1-3) or secured to the wheel rim 20 with fasteners 29 or the like (FIGS. 5, 6). Each of the tubes 14 includes an outer groove 15 to receive a sealing ring 16, and a bore 17 formed therein. Each of the ducts 22 includes an outer groove 23 to receive a sealing ring 24, and a bore 25 formed therein.

Each of the cushioning devices 3 includes one or more cushioning members 31, 32, such as springs 31 and/or spongy or soft or resilient pads 32 received in the bores 17, 25 of the tube 14 and the duct 22, for providing a resilient or cushioning force between the tube 14 and the duct 22, or between the hub 10 and the wheel rim 20. A barrel 33 is engaged between the tube 14 and the duct 22, to retain the springs 31 and/or the resilient pads 32 or the cushioning members 31, 32 in the bores 17, 25 of the tube 14 and the duct 22.

The barrel 33 is slidable relative to the tube 14 and the duct 22 and is made of harder plastic, composite or metal materials, to maintain the tube 14 and the duct 22 in a line, and to allow the tube 14 and the duct 22 to be moved toward or away from each other, due to the springs 31 and/or the resilient pads 32. Alternatively, as shown in FIGS. 5, 6, a longitudinal pad 32 may be engaged in the bores 17, 25 of the tube 14 and the duct 22, to maintain the tube 14 and the duct 22 in a line.

In operation, the springs 31 and/or the resilient pads 32 or the cushioning members 31, 32 may provide a resilient or cushioning force between the tube 14 and the duct 22, and thus between the hub 10 and the wheel rim 20, in order to cushion the wheel rim 20 relative to the hub 10 of the cycles, and to allow cycle riders to comfortably ride the cycles.

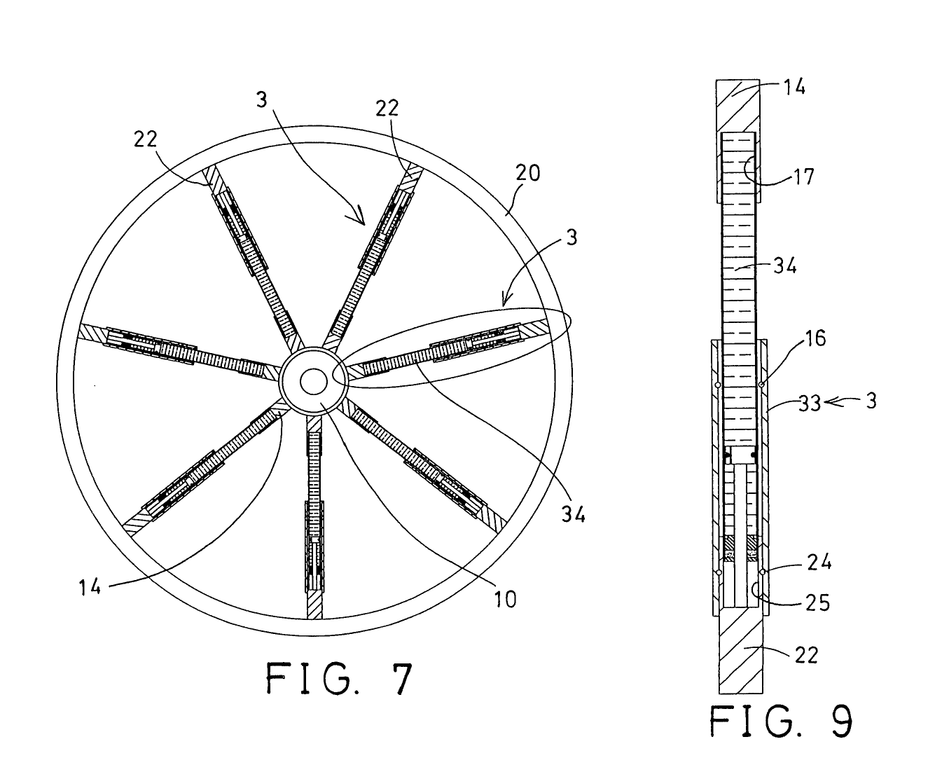

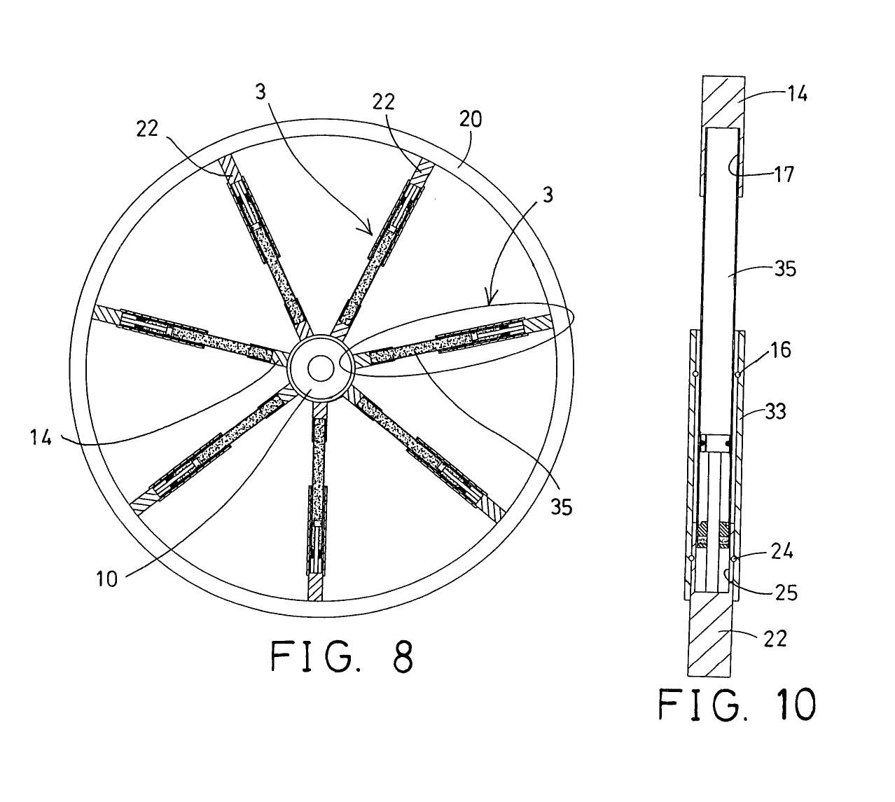

Referring next to FIGS. 7-10, alternatively, each of the cushioning devices 3 may include the other cushioning members 34, 35, such as hydraulic cylinders 34 (FIGS. 7, 9) or pneumatic cylinders 35 (FIGS. 8, 10) disposed between the tubes 14 and the ducts 22, or between the hub 10 and the wheel rim 20, instead of the springs 31 and/or the resilient pads 32, to provide a resilient or cushioning force between the tube 14 and the duct 22, and thus between the hub 10 and the wheel rim 20, in order to cushion the wheel rim 20 relative to the hub 10 of the cycles.

Accordingly, the wheel in accordance with the present invention includes a cushioning mechanism or device for cushioning the spokes or the wheel.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A wheel comprising:
a wheel rim,
a hub disposed within said wheel rim, and
a plurality of cushioning devices coupled between said hub and said wheel rim, to provide a cushioning force between said hub and said wheel rim.

2. The wheel as claimed in claim 1, wherein each of said cushioning devices includes a tube extended from said hub, and a duct extended from said wheel rim, and at least one cushioning member disposed between said tube and said duct, to provide a cushioning force between said tube and said duct and thus between said hub and said wheel rim.

3. The wheel as claimed in claim 2, wherein each of said tubes and said ducts includes a bore formed therein to receive said at least one cushioning member.

4. The wheel as claimed in claim 2, wherein said at least one cushioning member is a spring.

5. The wheel as claimed in claim 2, wherein said at least one cushioning member is a pad.

6. The wheel as claimed in claim 2, wherein each of said cushioning devices includes a barrel slidably engaged between said tube and said hub.

7. The wheel as claimed in claim 6, wherein each of said cushioning devices includes a sealing ring engaged between said barrel and said tube, and another sealing ring engaged between said barrel and said hub.

8. The wheel as claimed in claim 1, wherein said cushioning devices are hydraulic cylinders.

9. The wheel as claimed in claim 1, wherein said cushioning devices are pneumatic cylinders.
